(19) United States
(12) Patent Application Publication
(10) Pub. No.: US 2016/0305679 A1
(43) Pub. Date: Oct. 20, 2016

(54) AIR-CONDITIONING SYSTEM

(71) Applicant: MITSUBISHI ELECTRIC CORPORATION, Tokyo (JP)

(72) Inventors: Osamu NOGUCHI, Tokyo (JP); Kazutaka OGURA, Tokyo (JP)

(21) Appl. No.: 15/103,584

(22) PCT Filed: Mar. 27, 2014
(86) PCT No.: PCT/JP2014/058826

§ 371 Date: Jun. 10, 2016

(51) Int. Cl. F24F 11/00; G05B 15/02; F25B 13/00

(52) U.S. Cl. CPC F24F 11/006; F25B 13/00; F24F 11/0079; F24F 11/008; F24F 11/0086; G05B 15/02; F24F 2011/0067; F24F 2011/0057; F24F 2011/0083; F24F 2011/0082; F24F 2011/0061; F24F 2011/0071

(57) ABSTRACT

A centralized management apparatus includes a global map creation unit creating a global map specifying coordinates of the air-conditioning apparatuses on an integrated floor having a plurality of divided floors; a database storing a global map and a first region designation table specifying a plurality of regions on the global map; and a first table processing unit creating the first region designation table and a first air conditioning apparatus data table specifying coordinates of the air-conditioning apparatuses on the regions. A centralized controller includes a second table processing unit converting the coordinate of the air conditioning apparatus on the region into a coordinate of the air conditioning apparatus on the divided floor; and a floor map creation unit creating a floor map specifying the coordinate of the air conditioning apparatus on the divided floor, based on output from the second table processing unit.

### TECHNICAL FIELD

The present invention relates to an air-conditioning system.

### BACKGROUND ART

A management system, including a centralized controller configured to control a plurality of units of facility equipment such as indoor units of an air conditioning apparatus installed in a building or other structures, and a centralized management apparatus configured to collectively control a plurality of centralized controllers, has been proposed conventionally (see Patent Literatures 1 to 3, for example).

According to the techniques described in Patent Literatures 1 to 3, a plan view of a floor on which facility equipment is installed is displayed on a display unit of a centralized controller, and facility equipment is arranged on coordinates of the plan view. For example, controlling a particular unit of facility equipment involves designating an icon corresponding to the particular unit of facility equipment, and executing a command such as for starting operation and stop. Thereby, control of each unit of the facility equipment can be realized with use of the centralized controller.

Further, a centralized management apparatus is installed in a managers room of a building, for example, whereby it is possible to monitor and control a plurality of centralized controllers collectively. In other words, the centralized controllers and the centralized management apparatus are connected with each other in a manner capable of transmitting data (including wireless), and communicate with each other to control the facility equipment by either of them.

### CITATION LIST

### Patent Literature

Patent Literature 1: Japanese Unexamined Patent Application Publication No. 6-103200

Patent Literature 2: Japanese Unexamined Patent Application Publication No. 8-227491

Patent Literature 3: Japanese Unexamined Patent Application Publication No. 2003-317166

### SUMMARY OF INVENTION

### Technical Problem

Here, a centralized controller has a floor map including data such as coordinates on which facility equipment is installed. Further, respective centralized controllers are installed on different floors. As such, a centralized management apparatus has a global map including data such as coordinates on which the respective units of facility equipment are installed on the respective floors.

In the techniques of Patent Literatures 1 to 3, facility equipment (icon) on a floor map, held by a centralized controller, and facility equipment (icon) on a global map, held by a centralized management apparatus, do not have consistency regarding the coordinate data (position data). As such, in the techniques of Patent Literatures 1 to 3, the centralized controller side creates a floor map to designate the position of the facility equipment, and the centralized management apparatus side also creates a global map to designate the position of the facility equipment, and then the respective units of facility equipment in both maps are associated with each other.

In other words, in the techniques of Patent Literatures 1 to 3, it is necessary to designate the positions of the respective units of facility equipment in both the centralized controllers and the centralized management apparatus. This causes a problem of lack of convenience.

The present invention has been made to overcome the problem as described above. An object of the present invention is to provide an air-conditioning system capable of improving convenience.

### Solution to Problem

An air-conditioning system according to the present invention includes a centralized controller configured to control air-conditioning apparatuses provided on a plurality of divided floors; and a centralized management apparatus configured to manage the centralized controller, the centralized management apparatus including a global map creation unit configured to create a global map specifying coordinates of the air-conditioning apparatuses on an integrated floor comprising the divided floors; a database configured to store the global map and a first region designation table specifying a plurality of regions on the global map; and a first table processing unit configured to create the first region designation table and a first air conditioning apparatus data table specifying coordinates of the air-conditioning apparatuses on the regions, the centralized controller including a second table processing unit configured to convert each of the coordinates of the air conditioning apparatuses on each of the regions into a coordinate of the air conditioning apparatus on corresponding one of the divided floors, based on the first region designation table and the first air conditioning apparatus data table created on the centralized management apparatus; and a floor map creation unit configured to create a floor map specifying the coordinate of each of the air conditioning apparatuses on the divided floor, based on an output from the second table processing unit.

### Advantageous Effects of Invention

Since the air-conditioning system of the present invention has the configurations described above, it is possible to enhance convenience.

### BRIEF DESCRIPTION OF DRAWINGS

FIG. 1A is a schematic diagram illustrating a building in which an air-conditioning system, according to Embodiment 1 of the present invention, is installed.

FIG. 1B shows an example of a schematic configuration of the air-conditioning system according to Embodiment 1 of the present invention.

FIG. 2 is an explanatory diagram illustrating a refrigerant circuit and other configurations of the air-conditioning system shown in FIG. 1.

FIG. 3 is an explanatory diagram illustrating a data structure and the like of the air-conditioning system according to Embodiment 1 of the present invention.

FIG. 4 is a block diagram illustrating a centralized management apparatus and a centralized controller of the air-conditioning system according to Embodiment 1 of the present invention.

FIG. 5 is an explanatory diagram illustrating a global map, and icons on the global map, in the centralized management apparatus of the air-conditioning system according to Embodiment 1 of the present invention.

FIG. 6 is a table for explaining setting of floor ranges in the centralized management apparatus of the air-conditioning system according to Embodiment 1 of the present invention.

FIG. 7 is a table illustrating coordinates of icons of air-conditioning apparatuses and other items in the centralized management apparatus of the air-conditioning system according to Embodiment 1 of the present invention.

FIG. 8 is a table for explaining arithmetic operation performed by the respective centralized controllers of the air-conditioning system according to Embodiment 1 of the present invention.

FIG. 9 is a control flowchart of the air-conditioning system according to Embodiment 1 of the present invention.

FIG. 10A is an explanatory diagram illustrating floor maps, and icons on the floor maps, in a centralized controller (NO. 1) of an air-conditioning system according to Embodiment 2 of the present invention.

FIG. 10B is an explanatory diagram illustrating floor maps, and icons on the floor maps, in a centralized controller (NO. 2) of the air-conditioning system according to Embodiment 2 of the present invention.

FIG. 11A is a table illustrating setting of floor ranges in the centralized controller (NO. 1) of the air-conditioning system according to Embodiment 2 of the present invention.

FIG. 11B is a table illustrating setting of floor ranges in the centralized controller (NO. 2) of the air-conditioning system according to Embodiment 2 of the present invention.

FIG. 12A is a table illustrating coordinates of icons of air-conditioning apparatuses and other items in the centralized controller (NO. 1) of the air-conditioning system according to Embodiment 2 of the present invention.

FIG. 12B is a table illustrating coordinates of icons of air-conditioning apparatuses and other items in the centralized controller (NO. 2) of the air-conditioning system according to Embodiment 2 of the present invention.

FIG. 13 is a table illustrating matched coordinates held by the air-conditioning system according to Embodiment 2 of the present invention.

FIG. 14 is a table for explaining arithmetic operation performed by a centralized management apparatus of the air-conditioning system according to Embodiment 2 of the present invention.

FIG. 15 is a control flowchart of the air-conditioning system according to Embodiment 2 of the present invention.

### DESCRIPTION OF EMBODIMENTS

Embodiments of the present invention will be described hereinafter.

### Embodiment 1

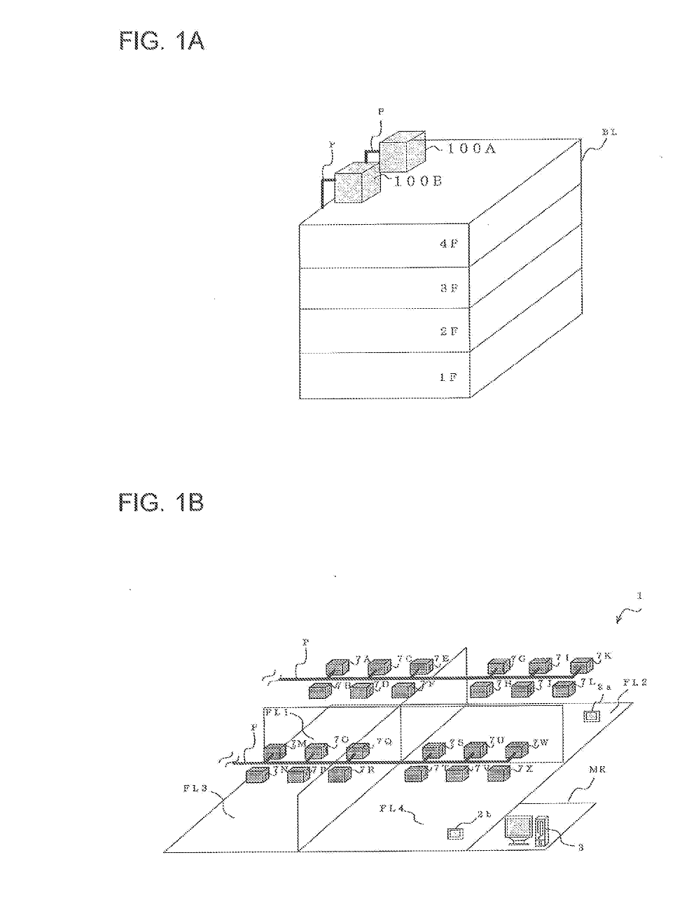

FIG. 1A is a schematic diagram showing a building BL in which an air-conditioning system 1 according to Embodiment 1 is installed. FIG. 1B shows an example of a schematic configuration of the air-conditioning system 1 according to Embodiment 1. With reference to FIG. 1A and FIG. 1B, an exemplary configuration of the case where the air-conditioning system 1 is installed in one building will be described.

The air-conditioning system 1 according to Embodiment 1 is improved to enhance convenience.

### Exemplary Overall Configuration of Air-Conditioning System 1

The air-conditioning system 1 is to be installed in premises such as a building BL, for example. In this example, the first floor of the building BL includes a building managers room MR, a floor FL1, a floor FL2, a floor FL 3, a floor FL4, and the like. It should be noted that each of the floor FL1, the floor FL2, the floor FL3, and the floor FL4 is a divided floor, and the floor FL1, the floor FL2, the floor FL3, and the floor FL4 are combined to form the integrated floor.

The building BL has stories from the first floor to the fourth floor, for example, and also has a rooftop where an outdoor unit 100A and other elements are installed. It should be noted that while description will be given mainly on the configurations of the first floor and the rooftop in Embodiment 1, air-conditioning apparatuses and other devices of the air-conditioning system 1 may be installed on the second to the fourth floors.

The air-conditioning system 1 includes air-conditioning apparatuses 7A to 7X, for example. In the below description, the air-conditioning apparatuses 7A to 7X may also be collectively referred to as an air conditioning apparatus 7. In Embodiment 1, description will be given exemplary on the case where the air-conditioning apparatuses 7A to 7X each are either an indoor unit or a ventilator of the air-conditioning apparatus. In this example, an indoor unit of the air-conditioning apparatus is one capable of performing a heating operation, a cooling operation, for example.

Further, a ventilator is one having a filter for collecting dust and other contamination, and being connected with a duct enabling the outside of the building BL and the inside of the building BL to communicate with each other, for example. The ventilator is configured to be able to discharge the air inside the building BL to the outside of the building BL, and supply fresh air outside the building BL to the inside of the building BL.

It should be noted that in Embodiment 1, the air conditioning apparatus 7A, the air conditioning apparatus 7C, the air conditioning apparatus 7E, the air conditioning apparatus 7G, the air conditioning apparatus 7I, the air conditioning apparatus 7K, the air conditioning apparatus 7M, the air conditioning apparatus 7O, the air conditioning apparatus 7Q, the air conditioning apparatus 7S, the air conditioning apparatus 7U, and the air conditioning apparatus 7W are indoor units of the air-conditioning apparatus. Further, the air conditioning apparatus 7B, the air conditioning apparatus 7D, the air conditioning apparatus 7F, the air conditioning apparatus 7H, the air conditioning apparatus 7J, the air conditioning apparatus 7L, the air conditioning apparatus 7N, the air conditioning apparatus 7P, the air conditioning apparatus 7R, the air conditioning apparatus 7T, the air conditioning apparatus 7V, and the air conditioning apparatus 7X are ventilators.

The air-conditioning system 1 includes an outdoor unit 100A connected with the air conditioning apparatus 7A which is an indoor unit of the air-conditioning apparatus, and other devices, via a refrigerant pipe P, and an outdoor unit 100B connected with the air conditioning apparatus 7M which is also an indoor unit of the air-conditioning apparatus, and other devices, via a refrigerant pipe P. The outdoor unit 100A and the outdoor unit 100B are installed on the rooftop of the building BL, for example.

The air-conditioning system 1 includes a centralized controller 2a configured to control the air-conditioning apparatuses 7A to 7L, a centralized controller 2b configured to control the air-conditioning apparatuses 7M to 7X, and a centralized management apparatus 3 configured to control the centralized controller 2a and the centralized controller 2b collectively. It should be noted that in the below description, the centralized controller 2a and the centralized controller 2b may collectively be referred to as a centralized controller 2. For example, the centralized controller 2a is installed on the floor FL2 of the first floor of the building BL, and the centralized controller 2b is installed on the floor FL4 of the first floor of the building BL. Further, the centralized management apparatus 3 is installed in the building managers room MR on the first floor of the building BL. The centralized management apparatus 3, the centralized controller 2a, and the centralized controller 2b are connected via wires or other elements so as to be communicable with each other. It should be noted that a connection between the centralized management apparatus 3, the centralized controller 2a, and the centralized controller 2b is not limited to a wire (wired connection). It may also be a wireless connection.

### Exemplary Refrigerant Circuit and other Configurations of Air-Conditioning System 1

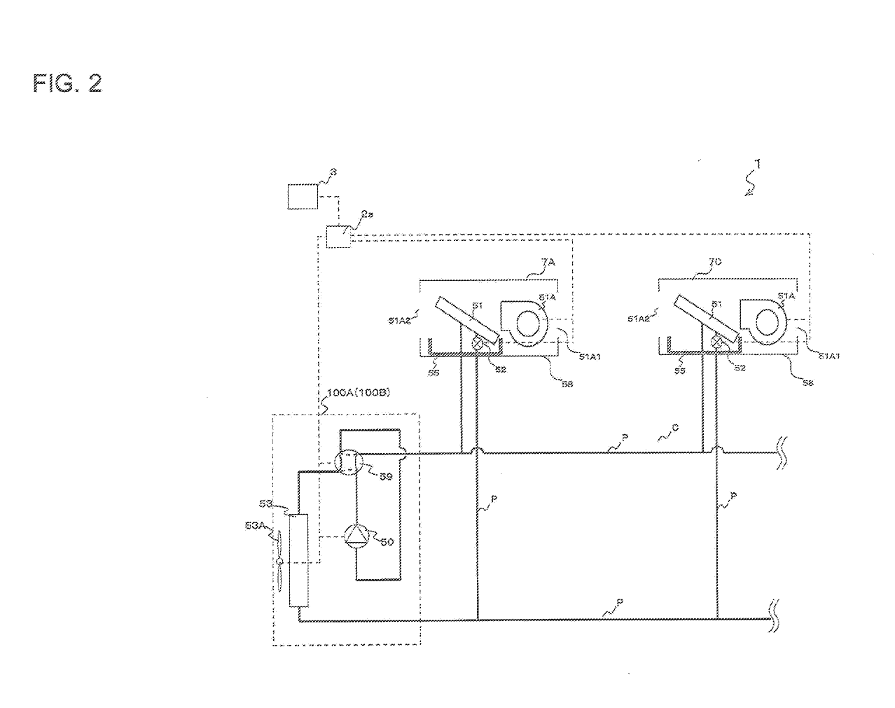

FIG. 2 is an explanatory diagram illustrating a refrigerant circuit and other configurations of the air-conditioning system 1 shown in FIG. 1B. With reference to FIG. 2, a configuration of a refrigerant circuit C, composed of the outdoor unit 100A, the air conditioning apparatus 7A, and other devices connected with each other via the refrigerant pipes P, and other elements will be described. It should be noted that the outdoor unit 100B, the air conditioning apparatus 7M, and the other devices also have a refrigerant circuit configured to be connected with each other via the refrigerant pipes P, but it is similar to the refrigerant circuit C composed of the outdoor unit 100A, the air conditioning apparatus 7A, and other devices, and therefore the description thereof is omitted,

The outdoor unit 100A and the outdoor unit 100B each are equipped with a compressor 50, a four-way valve 59 for switching between refrigerant flow channels, a heat source-side heat exchanger 53 functioning as a radiator or other elements, and other devices. Further, in the case where the heat source-side heat exchanger 53 provided to each of the outdoor unit 100A and the outdoor unit 100B is an air-cooled type heat exchanger, the heat source-side heat exchanger 53 is equipped with a blower device 53A configured to supply air to the heat source-side heat exchanger 53 and promote heat exchange between the supplied air and high-temperature and high-pressure refrigerant flowing through the heat source-side heat exchanger 53.

The compressor 50 sucks refrigerant, compresses the refrigerant to be in a high-temperature and high-pressure state, and discharges it. The compressor 50 is configured such that a refrigerant discharge side thereof is connected with a use-side heat exchanger 51, and a refrigerant suction side thereof is connected with the heat source-side heat exchanger 53. It should be noted that the compressor 50 may be formed of an inverter compressor, for example. The four-way valve 59 is used for switching among refrigerant flow channels between the time of heating operation and the time of cooling operation, for example. At the time of heating operation, the four-way valve 59 is switched to connect the discharge side of the compressor 50 and the use-side heat exchanger 51, and connect the heat source-side heat exchanger 53 and the suction side of the compressor 50. Further, at the time of cooling operation, the four-way valve 59 is switched to connect the discharge side of the compressor 50 and the heat source-side heat exchanger 53, and connect the use-side heat exchanger 51 and the suction side of the compressor 50.

At the time of heating operation, the heat source-side heat exchanger 53 allows heat exchange between refrigerant having flowed out from an expansion device 52 and a medium such as air. At the time of cooling operation, the heat source-side heat exchanger 53 allows heat exchange between high-temperature and high-pressure refrigerant discharged from the compressor 50 and a medium such as air. The heat source-side heat exchanger 53 is configured such that one side is connected with the four-way valve 59 and the other side is connected with the expansion device 52. It should be noted that if the heat source-side heat exchanger 53 is of an air-cooled type, it may be formed of a plate fin-and-tube type heat exchanger in which heat can be exchanged between the refrigerant flowing through the heat source-side heat exchanger 53 and the air passing through the fin, for example. The blower device 51A is composed of a motor, a fan connected with the motor via a rotating shaft, and other elements. It should be noted that in the blower device 51A, the rotation speed is controlled by the centralized controller 2a or other elements.

### (Centralized Controller 2)

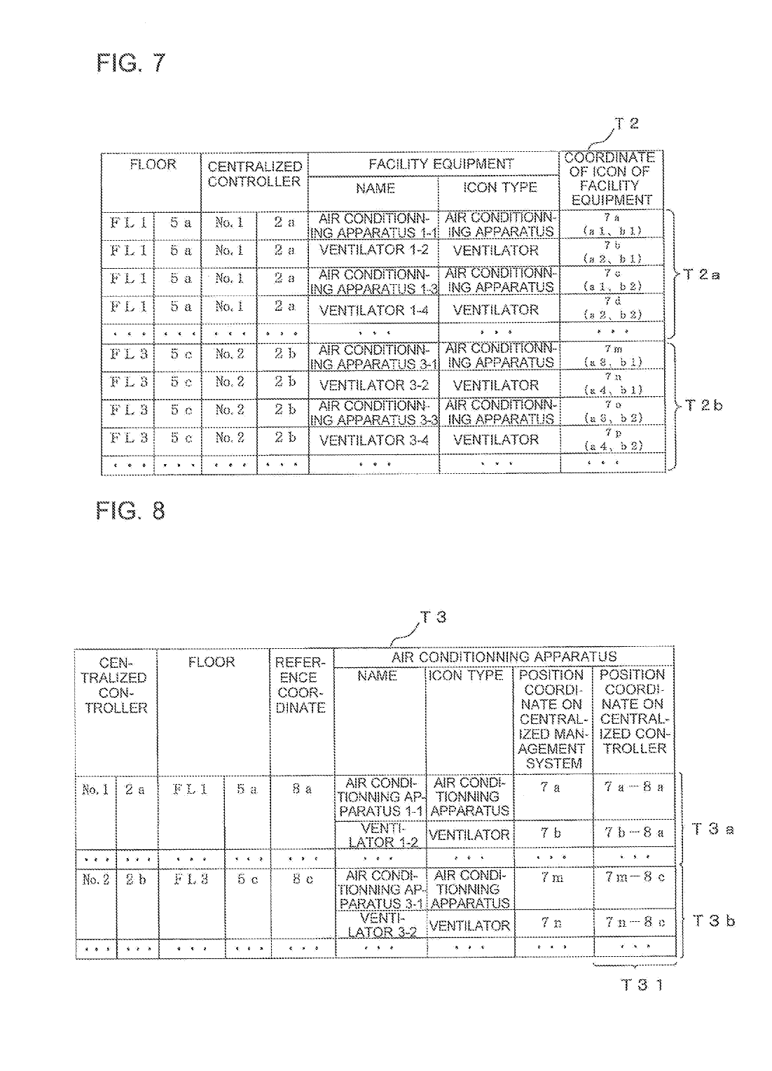

The centralized controller 2 includes a second information input unit 2A (see FIG. 7) composed of buttons, a touch panel, and other elements, for example, and receives temperature data such as preset temperature, wind direction data relating to the angle of wind direction plates and other elements, and air flow data of preset air flow, from a user via the second information input unit 2A. Further, the centralized controller 2 is connected with the centralized management apparatus 3 and also receives a command from the centralized management apparatus 3. Based on the data received from the second information input unit 2A, a command from the centralized management apparatus 3, and the like, the centralized controller 2 controls the rotation speed (including operation and stop) of the compressor 50, the rotation speed (including operation and stop) of the blower device 53A provided to the heat source-side heat exchanger 53 and the rotation speed of the blower device 51A provided to the use-side heat exchanger 51 the opening degree of the expansion device 52, switching between the flow channels of the four-way valve 59, and other elements. It should be noted that the centralized controller 2a may be composed of a controller such as a microcomputer, for example.

As the centralized controller 2 is managed by the centralized management apparatus 3, it is possible to control the rotation speed (including operation and stop) and other factors of the compressor 50 described above, even on the side of the centralized management apparatus 3.

### (Air Conditioner 7A and the Like)

While the refrigerant circuit C includes the air conditioning apparatus 7C and other elements in addition to the air conditioning apparatus 7A, description will be given on the air conditioning apparatus 7A as a representative element, in this example. The air conditioning apparatus 7A includes the expansion device 52, the use-side heat exchanger 51, the use-side heat exchanger 51, and a drain pan 55. Further, in a casing 58, the blower device 51A is mounted, which supplies air to the use-side heat exchanger 51, allows heat exchange between the supplied air and refrigerant flowing in the use-side heat exchanger 51, and supplies it to a space to be air-conditioned, for example. The casing 58 includes an air inlet 51A1 used for taking the air into the casing 58, and an air outlet 51A2 used for discharging the air to the outside of the casing 58.

The expansion device 52 is used for expanding refrigerant, and is configured such that one end is connected with the heat source-side heat exchanger 53 and the other end is connected with the use-side heat exchanger 51. It should be noted that the expansion device 52 may be composed of an electronic expansion valve whose opening degree is variable, a capillary tube, and other elements. The use-side heat exchanger 51 allows heat exchange between refrigerant flowing out of the expansion device 52 and a medium such as air, at the time of cooling operation. The use-side heat exchanger 51 also allows heat exchange between high-temperature and high-pressure refrigerant discharged from the compressor 50 and a medium such as air, at the time of heating operation. The use-side heat exchanger 51 is configured such that one end is connected with the four-way valve 59 and the other end is connected with the expansion device 52. It should be noted that the use-side heat exchanger 51 may be formed of a plate fin-and-tube type heat exchanger with which heat can be exchanged between the refrigerant flowing in the heat source-side heat exchanger 53 and the air passing through the fin.

The drain pan 55 is provided on the lower side of the use-side heat exchanger 51, and is used for storing water. The drain pan 55 is connected with a drainpipe not shown, and is configured such that the water stored in the drain pan 55 is drained through the drain pipe. The blower device 51A is used to take air into the casing 58 and supply the taken air from the inside of the casing 58 to a space to be air-conditioned. The blower device 51A is composed of a motor, a fan connected with the motor via a rotating shaft, and other elements. It should be noted that as for the blower device 51A, the rotation speed is controlled by the centralized controller 2a and other elements.

### Regarding Centralized Management Apparatus 3 and Centralized Controller 2

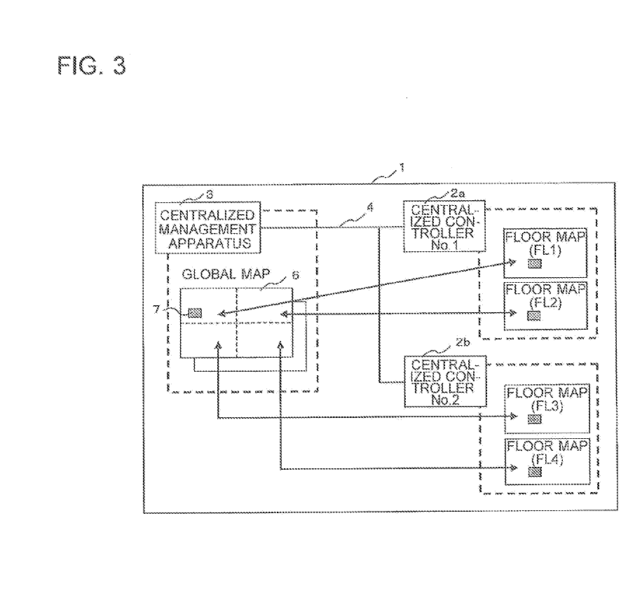

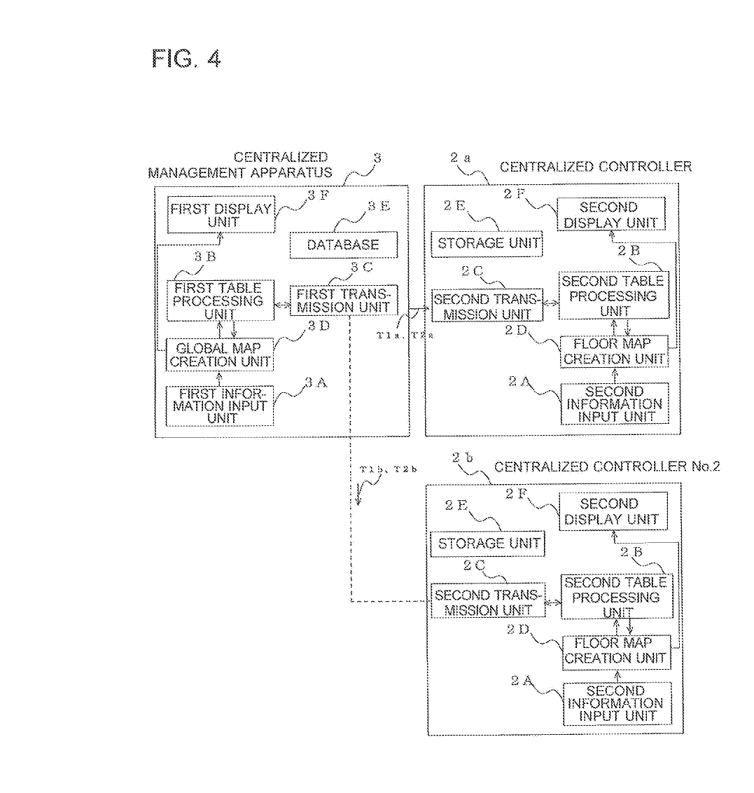

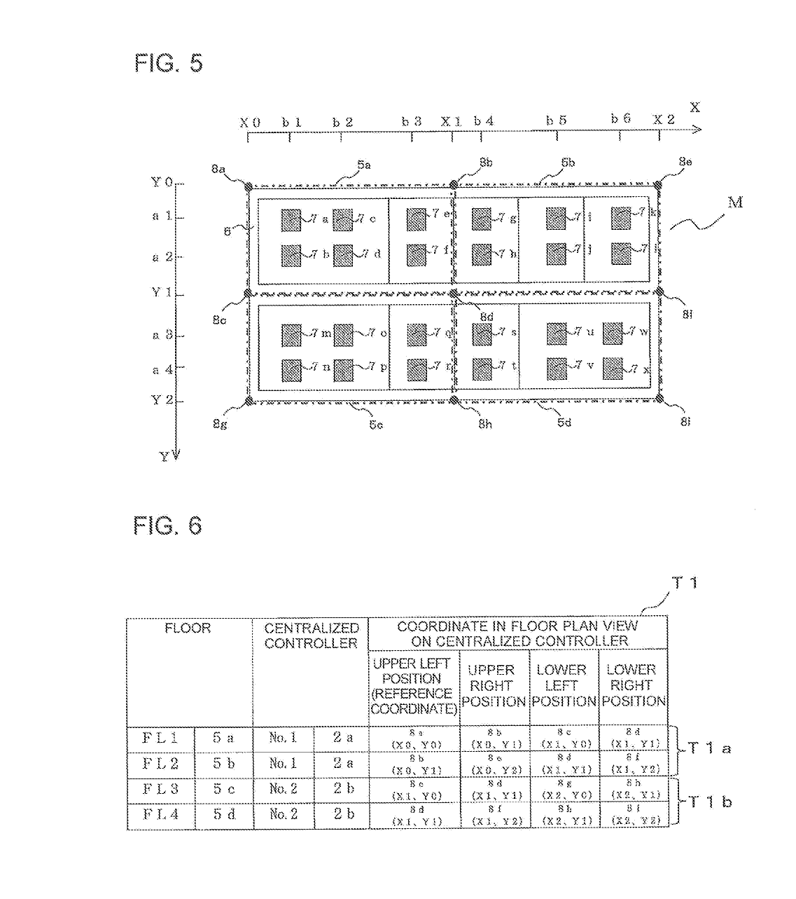

FIG. 3 is an explanatory diagram illustrating the data structure and the like of the air-conditioning system 1 according to Embodiment 1. FIG. 4 is a block diagram illustrating the centralized management apparatus 3 and the centralized controller 2 of the air-conditioning system 1 according to Embodiment 1. FIG. 5 is an explanatory diagram illustrating a global map M, and icons 7a to 7x on the global map M, in the centralized management apparatus 3 of the air-conditioning system 1 according to Embodiment 1. Configurations of the centralized management apparatus 3 and the centralized controller 2 will be described with reference to FIGS. 3 to 5.

### (Centralized Management Apparatus 3)

The centralized management apparatus 3 includes a first information input unit 3A used for acquiring data corresponding to a touch panel, buttons, a mouse, or other elements, for example, a global map creation unit 3D that creates a global map M, a first table processing unit 3B configured to perform various types of arithmetic operation based on the data acquired by the first information input unit 3A, a first transmission unit 3C configured to communicate with the centralized controller 2a and the centralized controller 2b, a database 3E in which various types of data is stored, and a first display unit 3F for displaying the global map M created by the global map creation unit 3D. It should be noted that the global map M is associated with respective floor maps FM, as shown in FIG. 3.

### (First Information Input Unit 3A)

The first information input unit 3A is used for setting ranges in which the entire coordinates of the global map M are in, setting coordinates of the air-conditioning apparatuses 7, setting the types of the air-conditioning apparatuses 7, and other aspects. The first information input unit 3A is also used for setting the air-conditioning apparatuses 7 to be operated or stopped, setting whether to perform heating operation or cooling operation, and other aspects. The data of the first information input unit 3A is output to the global map creation unit 3D.

### (Overview Map Creation Unit 3D)

The global map creation unit 3D creates a global map based on the data output from the first information input unit 3A. Specifically, the global map creation unit 3D defines coordinates of the global map M which is a planar map as shown in FIG. 5, sets ranges of regions 5a to 5d, arranges the icons 7a to 7x on the coordinates of the global map M, and so on.

It should be noted that data of the regions 5a to 5d is converted to the floor maps FM of the respective floors FL1 to FL4. Further, the icons 7a to 7x correspond to the air-conditioning apparatuses 7A to 7X. Further, while the floors FL1 to FL4 represent physical ranges, the regions 5a to 5d show coordinate ranges on the data.

The global map creation unit 3D outputs the data of the created global map M to the first display unit 3F. The global map creation unit 3D is also able to create icons representing operating states (operation, stop, heating operation, cooling operation, presence/absence of abnormality occurrence, and other states) of the air-conditioning apparatuses 7A to 7X, for example, besides the icons 7a to 7x representing the presence of the air-conditioning apparatuses 7A to 7X.

### (First Table Processing Unit 3B)

The first table processing unit 3B creates a first region designation table T1 and a first air conditioning apparatus data table T2, based on the data held by the global map creation unit 3D, the data in the database 3E, or other sources. It should be noted that the first table processing unit 3B stores the data of the created first region designation table T1 and the first air conditioning apparatus data table T2 in the database 3E. Further, the first table processing unit 3B outputs the created first region designation table T1 and the first air conditioning apparatus data table T2 to the global map creation unit 3D.

Here, in the case where the first region designation table T1 and the first air conditioning apparatus data table T2 have been created, when an input for data update is made by the first information input unit 3A for example, the first table processing unit 3B rewrites the data of the first region designation table T1 and the first air conditioning apparatus data table T2, based on the update data. For example, when the first table processing unit 3B receives data for update of the range of the region 5a from the first information input unit 3A, the first table processing unit 3B rewrites the range of the region 5a in the latest first region designation table T1, while does not change the ranges of the regions 5b to 5d in the latest first region designation table T1.

The first table processing unit 36 outputs the data of the first region designation table T1 and the first air conditioning apparatus data table T2, to the first transmission unit 3C. Then, the output data is transmitted to the centralized controller 2 described below. It should be noted that when an output is made from a second transmission unit 2C on the centralized controller 2, described below, to the centralized management apparatus 3, the first table processing unit 3B receives the output from the centralized controller 2 via the first transmission unit 3C. In this way, the centralized management apparatus 3 and the centralized controller 2 can share information by exchanging data with each other. In particular, as the coordinates (coordinate data) of the global map M of the centralized management apparatus 3 and the coordinates (coordinate data) of the floor maps FM of the centralized controller 2 are associated with each other, the coordinate data of one of the centralized management apparatus 3 and the centralized controller 2 can be used as coordinate data of the other one. Thereby, in the air-conditioning system 1, it is not necessary to set coordinate data independently for the centralized management apparatus 3 and the centralized controller 2, which enhances convenience.

### (First Transmission Unit 3C)

The first transmission unit 3C outputs the first region designation table T1 and the first air conditioning apparatus data table T2, output from the first table processing unit 3B, to the centralized controller 2. Specifically, the first transmission unit 3C outputs a table T1a of the first region designation table T1 and a table T2a of the first air conditioning apparatus data table T2, to the centralized controller 2a. The first transmission unit 3C also outputs a table T1b of the first region designation table T1 and a table T2b of the first air conditioning apparatus data table T2, to the centralized controller 2b.

Further, the first transmission unit 3C also has a function of receiving data output from the centralized controllers 2. The first transmission unit 3C is connected with the second transmission unit 2C of the centralized controller 2a and the second transmission unit 2C of the centralized controller 2b, described below, in a manner capable of performing data communications.

### (Database 3E)

The database 3E is able to exchange data with the first table processing unit 3B, the global map creation unit 3D, and other units, and store the exchanged data therein. The database 3E may be composed of a hard disk of a personal computer, for example.

### (First Display Unit 3F)

The first display unit 3F displays the global map M created by the global map creation unit 3D. A building manager is able to know the coordinates, operating states, and other aspects of the air-conditioning apparatuses 7 on the floor FL1 and the floor FL2, and the coordinates, the operating states, and other aspects of the air-conditioning apparatuses 7 on the floor FL2 and the floor FL3, by seeing the global map M displayed on the first display unit 3F.

### (Centralized Controller 2)

The centralized controller 2 has a configuration having a function corresponding to the centralized management apparatus 3. In other words, the centralized controller 2 includes a second information input unit 2A corresponding to the first information input unit 3A, a second table processing unit 2B corresponding to the first table processing unit 3B, a second transmission unit 2C corresponding to the first transmission unit 3C, a floor map creation unit 2D corresponding to the global map creation unit 3D, a storage unit 2E corresponding to the database 3E, and a second display unit 3F corresponding to the first display unit 3F.

### (Second Information Input Unit 2A)

The second information input unit 2A of the centralized controller 2a is used for inputting setting of the ranges of the entire coordinates of the floor map FM, setting of the coordinates of the air-conditioning apparatuses 7A to 7L, setting of the types of the air-conditioning apparatuses 7A to 7L, and so on, a touch panel, buttons, or other elements, correspond to the second information input unit 2A of the centralized controller 2a for example. Further, the second information input unit 2A of the centralized controller 2a is used for settings such as the air-conditioning apparatuses 7A to 7L that are to be operated and the air-conditioning apparatuses 7A to 7L that are to be stopped, and whether to perform heating operation or cooling operation. In other words, the centralized controller 2a controls the air conditioning apparatus 7A and other elements according to the input from the second information input unit 2A. It should be noted that the second information input unit 2A of the centralized controller 2b also has a configuration corresponding to the second information input unit 2A of the centralized controller 2a.

### (Floor Map Creation Unit 2D)

The floor map creation unit 2D is configured to create the floor map FM based on the data output from the second information input unit 2A. Specifically, the floor map creation unit 2D defines the coordinates of the floor map FM which is a planar map, sets icons on the coordinates of the floor map FM, and so on.

### (Second Table Processing Unit 2B)

The second table processing unit 2B creates a first coordinate conversion table T3 described below, and stores the data of the created table in the storage unit 2E. The second table processing unit 2B also outputs the data of the created table to the second transmission unit 2C. In the case where the table has been created, when an input requiring update of the data is made by the second information input unit 2A, for example, the second table processing unit 2B rewrites the data of the table based on the update data. It should be noted that the second table processing unit 2B of the centralized controller 2b also has a configuration corresponding to the second table processing unit 2B of the centralized controller 2a.

### (Second Transmission Unit 2C)

The second transmission unit 2C is a unit to which data of the first region designation table T1 and the first air conditioning apparatus data table T2, output via the first transmission unit 3C, is output. Further, the second transmission unit 2C also has a function of receiving data output from the centralized management apparatus 3.

### (Storage Unit 2E)

The storage unit 2E is able to exchange data with the second table processing unit 2B, the floor map creation unit 2D, and other units, and store the exchanged data. The storage unit 2E may be composed of a hard disk or a flash memory, for example.

### (Second Display Unit 2F)

The second display unit 2F displays the floor map FM created by the floor map creation unit 2D. A user, a building manager, or other personnel for the centralized controller 2a is able to know the coordinates and the operating states of the air-conditioning apparatuses 7A to 7L on the floor FL1 and the floor FL2, by seeing the floor map FM displayed on the second display unit 2F. Further, a user, a building manager, or other personnel for the centralized controller 2b is also able to know the coordinates and the operating states of the air-conditioning apparatuses 7M to 7X on the floor FL3 and the floor FL4, by seeing the floor map FM displayed on the second display unit 2F.

### Description of Table and the Like

FIG. 6 shows a table for explaining setting of floor ranges by the centralized management apparatus 3 of the air-conditioning system 1 according to Embodiment 1. FIG. 7 shows a table illustrating the coordinates of the icons 7a to 7x and other elements of the air-conditioning apparatuses 7 in the centralized management apparatus 3 of the air-conditioning system 1 according to Embodiment 1.

With reference to FIG. 6 and FIG. 7, the data (the first region designation table T1 and the first air conditioning apparatus data table T2) created by the centralized management apparatus 3, the data output from the centralized management apparatus 3 to the centralized controller 2, and other elements will be described.

The global map creation unit 3D of the centralized management apparatus 3 has the global map M showing the overall coordinates of the floors FL1 to FL4. Specifically, the global map M includes the regions 5a to 5d which are ranges of the coordinates set by a building manager or other personnel. It should be noted that while description is given on the global map M of the first floor of the building in Embodiment 1, the centralized management apparatus 3 has global maps M of the second to the fourth floors, respectively. In other words, the centralized management apparatus 3 has four global maps M.

The centralized management apparatus 3 is able to designate, via the first information input unit 3A, the region 5a that is a coordinate range corresponding to the floor FL1, the region 5b that is a coordinate range corresponding to the floor FL2, the region 5c that is a coordinate range corresponding to the floor FL3, and the region 5d that is a coordinate range corresponding to the floor FL4. In other words, the centralized management apparatus 3 has the first region designation table T1 showing the ranges of Y coordinates and X coordinates to which the respective regions 5a to 5d correspond, as shown in FIG. 6.

When the first table processing unit 3B receives data regarding the ranges of the regions 5a to 5d from the global map creation unit 3D, the first table processing unit 3B creates the first region designation table T1 based on the received data.

The first table processing unit 3B is able to create the first air conditioning apparatus data table T2 including the data in the range of the region 5a, the data in the range of the region 5b, the data in the range of the region 5c, and the data in the range of the region 5d. It should be noted that in FIG. 7, data of the region 5b and the region 5d is omitted.

Specifically, as shown in FIG. 7, the first air conditioning apparatus data table T2 is composed of data showing whether the centralized controllers 2 corresponding to the regions 5a to 5d each are the centralized controller 2a or the centralized controller 2b, data showing whether the air-conditioning apparatuses 7 corresponding to the regions 5a to 5d each are an indoor unit or a ventilator of the air-conditioning apparatus, data of the types of the icons 7a to 7x of the air-conditioning apparatuses 7, data of the coordinates of the air-conditioning apparatuses 7, and other data. As shown in FIG. 5 and FIG. 7, the coordinate data of the air conditioning apparatus 7A shows that the Y coordinate takes a1 and the X coordinate takes b1. Further, the coordinate data of the air conditioning apparatus 7M shows that the Y coordinate takes a3 and the X coordinate takes b1. These data values may be input by a building manager or other personnel.

FIG. 8 shows a table for explaining arithmetic operation performed by each centralized controller 2 of the air-conditioning system 1 according to Embodiment 1. A first coordinate conversion table T3 will be described with reference to FIG. 8.

The second table processing unit 2B of the centralized controller 2 creates the first coordinate conversion table T3, based on the first region designation table T1 and the first air conditioning apparatus data table T2 that are data on the side of the centralized management apparatus 3 output from the second transmission unit 2C. Specifically, the second table processing unit 2B of the centralized controller 2a creates a table T3a of the first coordinate conversion table T3, and the second table processing unit 2B of the centralized controller 2b creates a table T3b of the first coordinate conversion table T3.

The second table processing unit 2B of the centralized controller 2 converts the coordinates of the air-conditioning apparatuses 7 on the region 5a and the region 5b, into coordinates of the air-conditioning apparatuses 7 on the divided floors (floor FL1 and floor FL2), based on the first region designation table T1 and the first air conditioning apparatus data table T2. The first coordinate conversion table T3 includes converted coordinate data T31 that is data of the converted coordinates calculated by subtracting the reference coordinates of the first region designation table T1 from the coordinates of the icons 7a to 7l in the first air conditioning apparatus data table T2.

In Embodiment 1, description will be given on the case where a reference coordinate is set on an upper left position in the first region designation table T1. In other words, the second table processing unit 2B has reference coordinate data in which the region 5a corresponds to a reference coordinate 8a, the region 5b corresponds to a reference coordinate 8b, the region 5c corresponds to a reference coordinate 8c, and the region 5d corresponds to a reference coordinate 8d. The second table processing unit 2B of the centralized controller 2a converts the planar coordinate data of the global map M to planar coordinate data on the floor map FM, from the coordinate data of the icons 7a to 7l of the first air conditioning apparatus data table T2, based on the reference coordinate data in the first region designation table T1.

### Control Flow of Air-Conditioning System 1

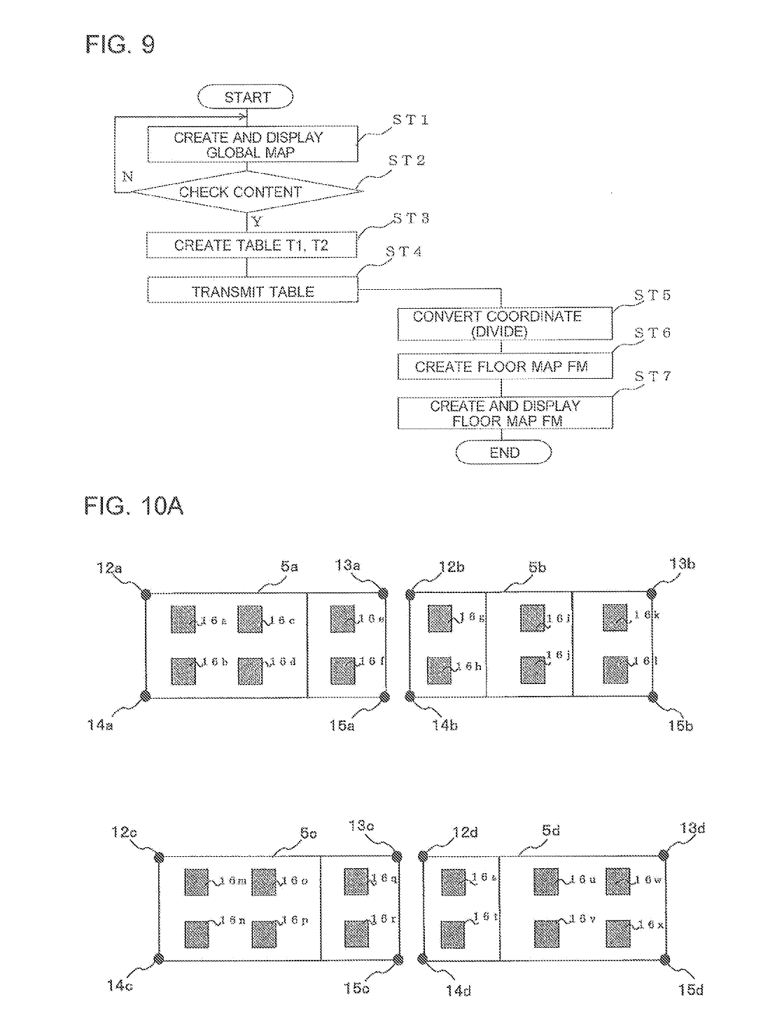

FIG. 9 is a control flowchart of the air-conditioning system 1 according to Embodiment 1. With reference to FIG. 9, description will be given on an operation of outputting data from the centralized management apparatus 3 to the centralized controller 2 in the air-conditioning system 1 to realize data sharing between the centralized management apparatus 3 and the centralized controller 2.

### (Step ST1)

The global map creation unit 3D arranges the icons 7a to 7x corresponding to the air-conditioning apparatuses 7A to 7X on the global map M, based on the data of the first information input unit 3A. Then, the first display unit 3F displays the global map M on which the icons 7a to 7x are arranged.

### (Step ST2)

The first display unit 3F displays whether or not it is allowed to proceed to the next step.

When a building manager or other personnel sets to proceed to the next step, the step proceeds to step ST3.

When the building manager or other personnel sets not to proceed to the next step, the first display unit 3F displays an input screen for inputting position data of the air conditioning apparatus 7, for example. Then, the step returns to step ST1.

### (Step ST3)

The first table processing unit 3B creates the first region designation table T1 and the first air conditioning apparatus data table T2 based on the output from the global map creation unit 3D. It should be noted that when there is no output from the first information input unit 3A and data is not updated, the first table processing unit 3B retrieves data of the latest first region designation table T1 and the first air conditioning apparatus data table T2 from the database 3E.

### (Step ST4)

The first transmission unit 3C outputs the first region designation table T1 and the first air conditioning apparatus data table T2, output from the first table processing unit 3B, to the centralized controller 2.

### (Step ST5)

The second table processing unit 2B converts the planar coordinate data of the global map M into planar coordinate data of the floor maps FM, based on the first region designation table T1 and the first air conditioning apparatus data table T2 acquired via the first transmission unit 3C and the second transmission unit 2C.

### (Step ST6)

The second table processing unit 2B creates the first coordinate conversion table T3 based on the first region designation table T1 and the first air conditioning apparatus data table T2, and the planar coordinate data of the floor maps FM converted at step ST5.

### (Step ST7)

The floor map creation unit 2C of the centralized controller 2a arranges the icons 7a to 7l corresponding to the air-conditioning apparatuses 7A to 7L on the floor maps FM, based on the first coordinate conversion table T3 output from the second table processing unit 2B. The second display unit 2F of the centralized controller 2a displays the floor maps FM on which the icons 7a to 7l are arranged.

The floor map creation unit 2D of the centralized controller 2b arranges the icons 7m to 7x corresponding to the air-conditioning apparatuses 7M to 7X on the floor maps FM, based on the first coordinate conversion table T3 output from the second table processing unit 2B. The second display unit 2F of the centralized controller 2b displays the floor maps FM on which the icons 7a to 7l are arranged.

### Effects of Air-Conditioning System 1 according to Embodiment 1

In the air-conditioning system 1 according to Embodiment 1, the centralized management apparatus 3 creates the first region designation table T1 and the first air conditioning apparatus data table T2, and the centralized controller 2 creates the first coordinate conversion table T3, and the planar coordinate data of the global map M can be converted into planar coordinate data of the floor maps FM. Specifically, in the air-conditioning system 1, the planar coordinate data of the global map M can be converted into planar coordinate data of the floor maps FM by subtracting the reference coordinates 8a to 8d in the first region designation table T1 from the coordinates of the icons 7a to 7x of the air-conditioning apparatuses 7A to 7X in the first air conditioning apparatus data table T2. In this way, in the air-conditioning system 1 of Embodiment 1, coordinate data of the centralized management apparatus 3 can be converted into coordinate data of the centralized controller 2, the coordinate data is shared, and it is not necessary to set coordinate data separately for the centralized management apparatus 3 and the centralized controller 2, whereby convenience is enhanced and the maintenance property is enhanced.

In the air-conditioning system 1 according to Embodiment 1, description has been given on the case where the global map M includes four regions 5a to 5d. However, the present invention is not limited to this case, and other configurations are applicable as long as the global map M includes two or more regions.

While it has been described that the air-conditioning apparatuses 7A to 7X each are an indoor unit or a ventilator of the air-conditioning apparatus in the air-conditioning system 1 according to Embodiment 1, the air-conditioning system 1 is not limited to this. For example, all of the air-conditioning apparatuses 7A to 7X may be indoor units of the air-conditioning apparatus, or all of the air-conditioning apparatuses 7A to 7X may be ventilators. Further, the air-conditioning apparatuses 7A to 7X may be refrigerating devices such as showcases and refrigerators.

While an exemplary configuration of comprehensively controlling the air-conditioning apparatuses 7A to 7X in one building BL has been described in Embodiment 1, the present invention is not limited to this. For example, a configuration of controlling air-conditioning apparatuses in a plurality of building by a centralized management apparatus provided on a predetermined place is also acceptable.

### Embodiment 2

FIG. 10A and FIG. 10B are explanatory diagrams illustrating floor maps FM of respective centralized controllers 2, and icons 16a to 16x on the floor maps FM, of an air-conditioning system 1 according to Embodiment 2. It should be noted that FIG. 10A shows floor maps FM of a centralized controller 2a, and FIG. 10B shows floor maps FM of a centralized controller 2b. In Embodiment 2, configurations common to those of Embodiment 1 are denoted by the same reference signs, and description will be given mainly on different points.

In Embodiment 1, data (table) is output from the centralized management apparatus 3 to the centralized controllers 2, and the regions 5a to 5d of the global map M are divided to be converted into the floor maps FM. On the other hand, in Embodiment 2, data (table) is output from the centralized controllers 2 to the centralized management apparatus 3, and the respective floor maps FM are combined to be converted into a global map M.

As shown in FIG. 10A, the centralized controller 2a includes the floor maps FM showing the entire coordinates of the floor FL1 and the floor FL2. Similarly, as shown in FIG. 10B, the centralized controller 2b includes the floor maps FM showing the entire coordinates of the floor FL3 and the floor FL4.

### Description of Table and the Like

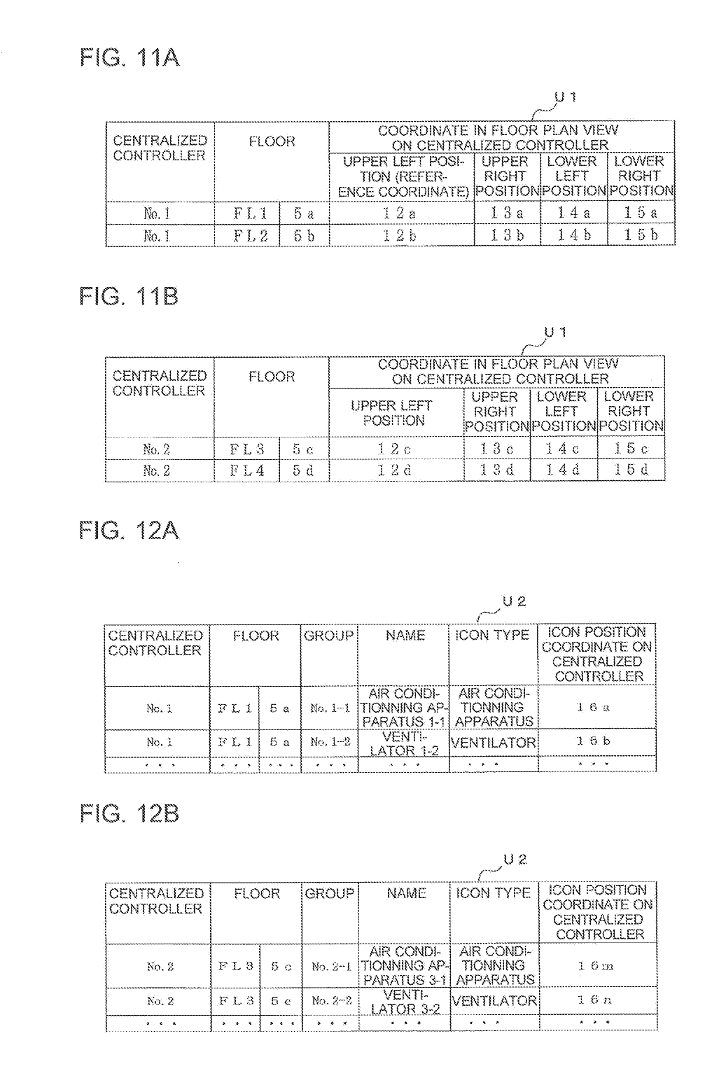

FIG. 11A and FIG. 11B are tables for setting floor ranges in the centralized management apparatus 3 of the air-conditioning system 1 according to Embodiment 2. FIG. 12A and FIG. 12B are tables illustrating the coordinates of the icons 16a to 16x of the air-conditioning apparatuses 7A to 7X and the like, in the centralized controller 2 of the air-conditioning system 1 according to Embodiment 2.

The first table processing unit 3B of the centralized management apparatus 3 creates a second region designation table U1 in which a coordinate range (a range surrounded by reference characters 12a to 15a in FIG. 10) on the floor map FM corresponding to the floor FL1 is associated with a region 5a that is a coordinate region corresponding to the floor FL1, and a coordinate range (a range surrounded by reference characters 12b to 15b in FIG. 10) on the floor map FM corresponding to the floor FL2 is associated with a region 5b that is a coordinate range corresponding to the floor FL2. When the centralized management apparatus 3 receives data showing the ranges of the region 5a and the region 5b from a building manager or other personnel, the centralized management apparatus 3 creates the second region designation table U1 based on the received data.

Similarly, the first table processing unit 3B also creates the second region designation table U1 regarding the floor FL3 and the floor FL4.

FIG. 10A, described above, schematically shows a state where the floor maps FM, on which the icons 16a to 16l corresponding to the air conditioning apparatus 7A to 7L and the regions 5a to 5b are arranged, are displayed on the second display unit 2F.

The centralized controller 2a is able to create a second air conditioning apparatus data table U2 including data of the region 5a corresponding to the coordinate range of the floor FL1, and data of the region 5b corresponding to the coordinate range of the floor FL2. Specifically, as shown in FIG. 12A, the second air conditioning apparatus data table U2 is composed of data showing whether the centralized controller 2 corresponding to the region 5a and the region 5b is the centralized controller 2a or the centralized controller 2b, data showing whether the air-conditioning apparatuses 7 corresponding to the region 5a and the region 5b are indoor units or ventilators of the air-conditioning apparatus, data of the types of the icons 16a to 16x of the air-conditioning apparatuses 7, data of the coordinates of the air-conditioning apparatuses 7, and other data.

It should be noted that the data of the coordinates of the air-conditioning apparatuses 7 in the second air conditioning apparatus data table U2 include data of Y coordinates and X coordinates, similar to the icon coordinates of the centralized management apparatus 3 shown in FIG. 6, although not shown in FIG. 12A and FIG. 12B. Further, as for the centralized controller 2b, it also creates the second region designation table U1 shown in FIG. 12B, and has a similar configuration and performs a similar operation to those of the centralized controller 2a.

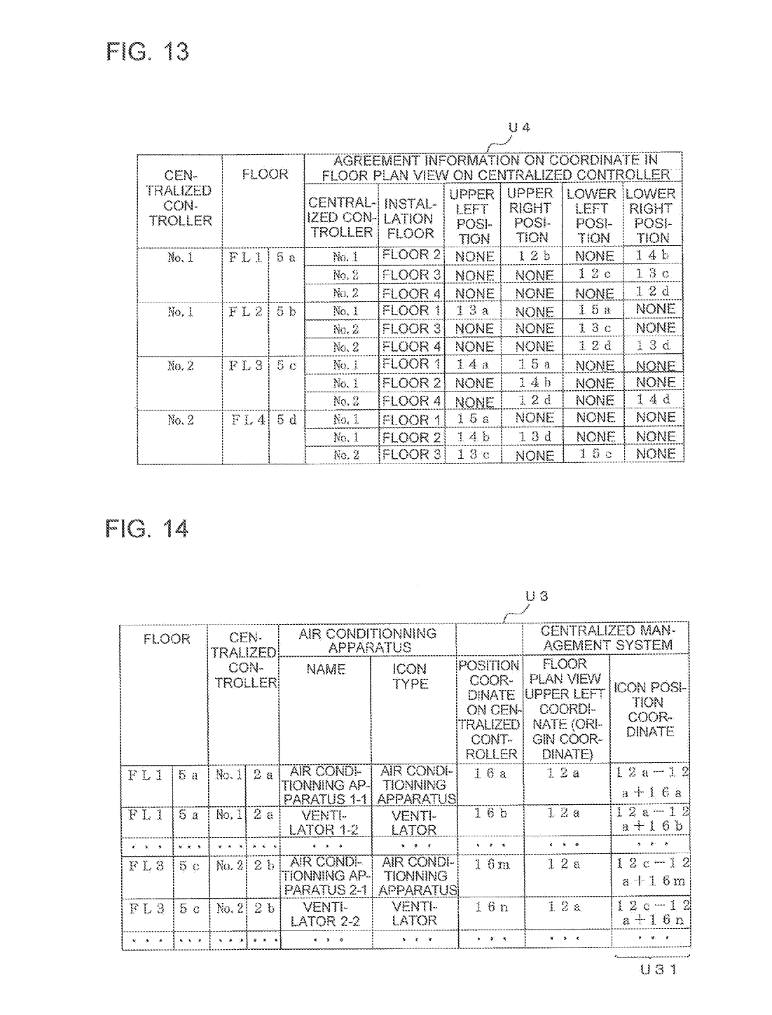

FIG. 13 is a table specifying matched coordinates, held by the air-conditioning system 1 according to Embodiment 2. The centralized management apparatus 3 has a coordinate agreement data table U4 shown in FIG. 13. The coordinate agreement data table U4 is a table specifying which coordinate in one floor map FM, of the floor maps FM adjacent to each other, agrees which coordinate of the other floor map FM, when creating the global map M. For example, in the global map M, the right end of the floor map FM corresponding to the floor FL1 matches the left end of the floor map FM corresponding to the floor FL2 (see FIG. 4). As such, the coordinate agreement data table U4 is set such that the upper right position (coordinate 13a) of the floor FL1 agrees the coordinate 12b of the floor FL2, and the lower right position (coordinate 15a) of the floor FL1 agrees the coordinate 14b of the floor FL2.

The coordinate agreement data table U4 may be created by a building manager via the first information input unit 3A, for example.

### Regarding Centralized Controller 2

The second table processing unit 2B outputs data of the second air conditioning apparatus data table U2 to the second transmission unit 2C. Then, the output data is transmitted to the centralized management apparatus 3.

The floor map creation unit 2D creates the floor maps FM based on the second air conditioning apparatus data table U2 output from the second table processing unit 2B or the table stored in the storage unit 2E. When creating the floor maps FM, the floor map creation unit 2D is able to create them according to the data (second air conditioning apparatus data table U2) from the second information input unit 2A, or the first coordinate conversion table T3 described in Embodiment 1.

For example, the floor map creation unit 2D of the centralized controller 2a shows the ranges of the region 5a and the region 5b on the coordinates of the floor maps FM that are planar maps, and arranges the icons 16a to 16l corresponding to the air-conditioning apparatuses 7A to 7L of the floor FL1 and the floor FL2, on the coordinates of the floor maps FM. The floor map creation unit 2D outputs the data of the created floor maps FM to the second display unit 2F. Further, the floor map creation unit 2D also shows the operating states (operation, stop, heating operation, cooling operation, presence/absence of occurrence of abnormality, and other states) and other aspects of the air-conditioning apparatuses 7A to 7L in the icons 16a to 16l corresponding to the air-conditioning apparatuses 7A to 7L.

### Regarding Centralized Management Apparatus 3

FIG. 14 is a table for explaining arithmetic operation performed by the centralized management apparatus 3 of the air-conditioning system 1 according to Embodiment 2. The first table processing unit 3B creates a second coordinate conversion table U3, based on the second air conditioning apparatus data table U2 acquired via the first information input unit 3A, and the second region designation table U1 and the coordinate agreement data table U4 held by itself. It should be noted that the first table processing unit 3B stores the created data of the second coordinate conversion table U3 in the database 3E.

As shown in the right end portion of FIG. 14, the second coordinate conversion table U3 includes converted data U31 having data of the converted coordinates calculated by adding the reference coordinate in the second region designation table U1 and the coordinates of the icons 16a to 16l in the second air conditioning apparatus data table U2, and subtracting the origin coordinate (coordinate 12a) at the upper left position of the floor FL1, serving as the reference, from the added coordinate.

In other words, the first table processing unit 3B of the centralized management apparatus 3 converts the planar coordinate data of the floor map FM into planar coordinate data of the global map M, based on the second region designation table U1, the second air conditioning apparatus data table U2, and the coordinate agreement data table U4.

In this example, description is given exemplary on the case where the floor FL1, among the floors FL1 to FL4, is set as a reference divided floor, and the origin coordinate (coordinate 12a) is set on the coordinate corresponding to the floor FL1, for the sake of convenience.

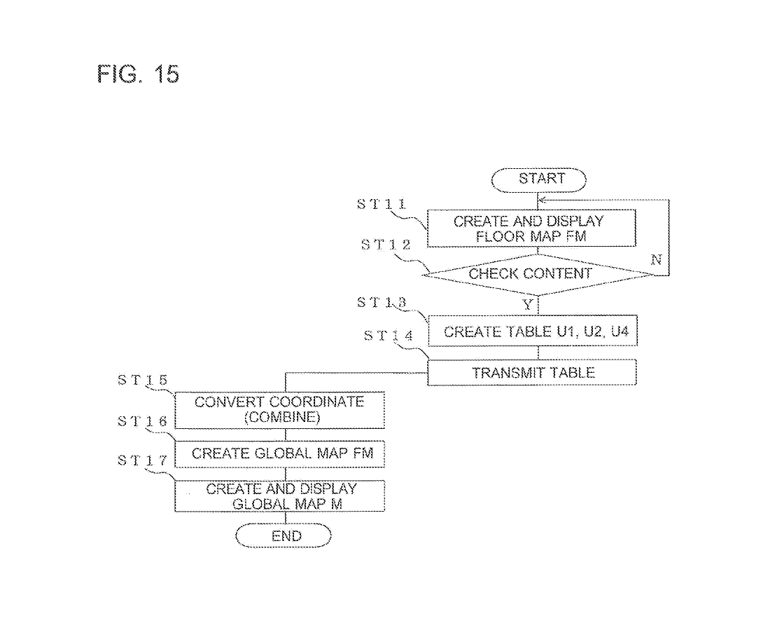

FIG. 15 is a control flowchart of the air-conditioning system 1 according to Embodiment 2. With reference to FIG. 15, an operation of outputting data from the centralized controller 2 to the centralized management apparatus 3 in the air-conditioning system 1 to allow the centralized management apparatus 3 and the centralized controller 2 to share the data will be described.

### (Step ST11)

The floor map creation unit 2D arranges the icons 16a to 16l corresponding to the air-conditioning apparatuses 7A to 7L on the floor maps FM, based on the output from the second information input unit 2A. The second display unit 2F displays the floor maps FM on which the icons 16a to 16l are arranged.

### (Step ST12)

The second display unit 2F displays whether or not it is allowed to proceed to the next step.

When a building manager or other personnel sets to proceed to the next step, the step proceeds to step ST13.

When the building manager or other personnel sets not to proceed to the next step, the second display unit 2F displays an input screen for inputting position data of the air conditioning apparatus 7, for example. Then, the step returns to step ST11.

### (Step ST13)

The second table processing unit 2B creates the second air conditioning apparatus data table U2 based on the output from the floor map creation unit 2D. It should be noted that if there is no output from the second information input unit 2A and the data is not updated, the second table processing unit 2B retrieves data of the latest second air conditioning apparatus data table U2 from the storage unit 2E.

### (Step ST14)

The second transmission unit 2C outputs the second air conditioning apparatus data table U2, output from the second table processing unit 2B, to the centralized management apparatus 3.

### (Step ST15)

The first table processing unit 3B converts the planar coordinate data of the floor maps FM into planar coordinate data of the global map M, based on the second air conditioning apparatus data table U2 acquired via the second transmission unit 2C and the first transmission unit 3C, and the second region designation table U1 and the coordinate agreement data table U4 held by itself.

### (Step ST16)

The first table processing unit 3B creates the second coordinate conversion table U3, based on the second region designation table U1, the second air conditioning apparatus data table U2, and the data converted at step ST15.

### (Step ST17)

The global map creation unit 3D creates the global map M based on the second coordinate conversion table U3 of the first table processing unit 3B. The first display unit 3F displays the global map M on which the icons are arranged.

### Effects of Air-Conditioning System 1 according to Embodiment 2

The air-conditioning system 1 according to Embodiment 2 has similar effects as those of the air-conditioning system 1 according to Embodiment 1.

It should be noted that in Embodiments 1 and 2, description has been given that the centralized management apparatus 3 includes the first information input unit 3A, the first table processing unit 3B, the first transmission unit 3C, the global map creation unit 3D, the database 3E, and the first display unit 3F, and that the centralized controller 2 includes the second information input unit 2A, the second table processing unit 2B, the second transmission unit 2C, the floor map creation unit 2D, the storage unit 2E, and the second display unit 2F. However, the present invention is not limited to this.

For example, the centralized management apparatus 3 may include the first information input unit 3A, the first table processing unit 3B, the first transmission unit 3C, the global map creation unit 3D, the database 3E, the first display unit 3F, the second table processing unit 2B, and the floor map creation unit 2D. Then, the centralized controller 2 may include the second information input unit 2A, the second transmission unit 2C, and the second display unit 2F. In such a configuration, the centralized controller 2 does not create the floor maps FM and various types of tables, and has only limited functions such as a function of receiving inputs and a function of displaying floor maps. The centralized management apparatus 3 has a function of creating maps and tables, for example.

### REFERENCE SIGNS LIST

1 air-conditioning system 2 centralized controller 2A second information input unit 2B second table processing unit 2C second transmission unit 2D floor map creation unit 2E storage unit 2F second display unit 2a centralized controller 2b centralized controller 3 centralized management apparatus 3A first information input unit 3B first table processing unit 3C first transmission unit 3D global map creation unit

3E database 3F first display unit 5a to 5d region 7 air conditioner 7A to 7X air conditioner 7a to 7x icon 8a to 8d reference coordinate 16a to 16x icon 50 compressor 51 use-side heat exchanger 51A blower device

51A1 air inlet 51A2 air outlet 52 expansion device 53 heat source-side heat exchanger 53A blower device 55 drain pan 58 housing 59 four-way valve 100A outdoor unit 100B outdoor unit

BL building C refrigerant circuit FL1 to FL4 floor FM floor map

M global map MR building manager's room P refrigerant pipe T1 first region designation table T2 first air conditioning apparatus data table T3 first coordinate conversion table T31 converted data U1 second region designation table U2 second air conditioning apparatus data table U3 second coordinate conversion table U31 converted data U4 coordinate agreement data table.

1. An air-conditioning system comprising:
a centralized controller configured to control air-conditioning apparatuses provided on a plurality of divided floors; and
a centralized management apparatus configured to manage the centralized controller,
the centralized management apparatus being configured to
create a global map specifying coordinates corresponding to positions of the air-conditioning apparatuses on an integrated floor comprising the divided floors, and
create a first region designation table specifying the global map and a plurality of regions on the global map and a first air conditioning apparatus data table specifying coordinates of the air-conditioning apparatuses on the regions,
the centralized controller being configured to
convert each of the coordinates of the air conditioning apparatuses on each of the regions into a coordinate corresponding to a position of the air conditioning apparatus on corresponding one of the divided floors, based on the first region designation table and the first air conditioning apparatus data table created on the centralized management apparatus, and
create a floor map specifying the coordinate of each of the air conditioning apparatuses on the divided floor, based on the coordinate corresponding to the position of the corresponding one of the air conditioning apparatuses on the divided floor.

2. The air-conditioning system of claim 1, wherein
the centralized controller is configured to
determine a reference coordinate for each of the regions based on the first region designation table, and
create a first coordinate conversion table specifying a converted coordinate calculated by subtracting the reference coordinate from the coordinate of the air conditioning apparatus on the region in the first air conditioning apparatus data table.

3. An air-conditioning system comprising:
a centralized controller configured to control air-conditioning apparatuses provided on a plurality of divided floors; and
a centralized management apparatus configured to manage the centralized controller,
the centralized controller being configured to
create, for each of the divided floors, a floor map specifying a coordinate corresponding to a position of each of the air conditioning apparatuses; and
create a second air conditioning apparatus data table specifying the coordinate of each of the air conditioning apparatuses on the floor map,
the centralized management apparatus being configured to
create a second region designation table specifying a plurality of regions on the floor maps, and a coordinate agreement data table specifying coordinates to agree with each other among coordinates of the regions,
create a global map specifying coordinates corresponding to positions of the air-conditioning apparatuses on an integrated floor, based on the second region designation table and the coordinate agreement table, and
combine the regions, and convert the coordinates of the air-conditioning apparatuses on the regions into coordinates of the air-conditioning apparatuses on the global map, based on the second region designation table, the second air conditioning apparatus data table, and the coordinate agreement data table.

4. The air-conditioning system of claim 3, wherein
the centralized management apparatus is configured to
determine a reference coordinate for each of the regions and an origin coordinate for the regions, and
create the second coordinate conversion table specifying converted coordinates each calculated by adding the reference coordinate to, and subtracting the origin coordinate from, the coordinate of the air conditioning apparatus on the region in the second air conditioning apparatus data table.

5. The air-conditioning system of claim 2, wherein
the centralized management apparatus arranges icons representing the coordinates of the air-conditioning apparatuses on the coordinates of the global map.

6. The air-conditioning system of claim 4, wherein
the centralized management apparatus arranges icons representing the coordinates of the air-conditioning apparatuses on the coordinates of the global map.
